(19) United States
(12) Patent Application Publication
(10) Pub. No.: US 2011/0307337 A1
(43) Pub. Date: Dec. 15, 2011

(54) System and Method for Mobile Advertising Platform

(75) Inventors: Sebastian Mikkel Wilson, Pleasanton, CA (US); Ilan Dar, San Jose, CA (US)

(73) Assignee: SYBASE 365, INC., Reston, VA (US)

(21) Appl. No.: 12/796,894

(22) Filed: Jun. 9, 2010

(51) Int. Cl. G06Q 30/00

(52) U.S. Cl. 705/14.64

(57) ABSTRACT

Leveraging the ubiquitous nature of Wireless Devices (WDs), the popularity of different messaging paradigms, and the advantageous response rate that is associated with messaging-based advertising, an infrastructure that augments messages with advertising in dynamic, intelligent, etc. ways (based on various constraints including for example the body of a message, characteristics of a Mobile Subscriber [MS], the current physical location of a MS' WD, a particular advertising campaign's characteristics, etc.). The infrastructure may optionally leverage the capabilities of a centrally-located Messaging Inter-Carrier Vendor.

### FIELD OF THE INVENTION

The present invention relates generally to telecommunications services. More particularly, the present invention relates to capabilities that enhance substantially the value and usefulness of various messaging paradigms including, inter alia, Short Message Service (SMS), Multimedia Message Service (MMS), Internet Protocol (IP) Multimedia Subsystem (IMS), etc.

### BACKGROUND OF THE INVENTION

As the ‘wireless revolution’ continues to march forward the importance to a Mobile Subscriber (MS)—for example a user of a Wireless Device (WD) such as a cellular telephone, a BlackBerry, a Palm Pilot, etc. that is serviced by an entity such as a Wireless Carrier (WC)—of their WD grows substantially.

One consequence of such a growing importance is the resulting ubiquitous nature of WDs—i.e., MSs carry them at almost all times and use them for an ever-increasing range of activities.

Coincident with the expanding presence of WDs has been the explosive growth of different messaging paradigms—a steady annual increase, year over year, in the number of (SMS, MMS, etc.) messages that have been exchanged by and between WDs. That steady increase shows no sign of abating. For example, looking at just the SMS and MMS messaging traffic in the U.S. one has:

| Year | Number of SMS (Millions) | Number of MMS (Millions) |
|---|---|---|
| 2009 | 1,517,267 | 25,503 |
| 2008 | 856,800 | 14,586 |
| 2007 | 351,205 | 8,323 |
| 2006 | 152,424 | 3,813 |
| 2005 | 73,317 | 347 |

The messaging that was quantified above may be categorized first by type:

1) Peer-to-Peer (or P2P) communication, wherein for example one peer, MS₁, may employ their WD (which is serviced perhaps by WC₁) to send messages to the WD of another peer, MS₂, (whose WD is serviced perhaps by WC₂) and MS₂ may optionally reply to the received messages, and

2) Application-to-Peer (A2P) communication, wherein a peer, MS₁, may employ their WD (which is serviced perhaps by WC₁) to send messages to and/or receive messages from an application or a system that may reside within a Service Provider (SP).

and then by orientation:

1) Mobile Originated (MO), wherein a MS sends a (SMS, MMS, etc.) message from their WD, and

2) Mobile Terminated (MT), wherein a MS receives a (SMS, MMS, etc.) on their WD.

Illustrative examples of A2P communication include, possibly inter alia, content distribution mechanisms wherein a MS may employ their WD to subscribe to, request or initiate (via search, etc.), confirm, authorize, etc. the distribution of content (which might include, possibly inter alia, news items, traffic alerts, weather notices, travel advisories, stock quotations, advertisements, coupons, educational factoids, games, movies, songs, etc.) to their WD; voting initiatives (such as the initiative that is offered by the television show American Idol®) wherein a MS may employ their WD to register a vote; trivia campaigns wherein a MS may employ their WD to submit an answer or a response to a trivia question; etc.

The specific examples that were described above are illustrative only and it will be readily apparent to one of ordinary skill in the relevant art that numerous other examples are easily possible and indeed are fully within the scope of the present invention.

Recently, selected A2P MT messages have begun to be augmented with advertising to inter alia take advantage of the ‘empty’ real estate that is frequently available within such messages. Such augmentation remains nascent, including for example the static addition of a simple text string (e.g., “Coke® is on sale at Buy Right Stores!”) at the end of an A2P MT SMS message.

Even though nascent, a 2008 Juniper Research report illustrates that SMS-based advertising is more than twice as effective as the next closest advertising medium:

| Medium | Advertisement Recipient Response Rate |
|---|---|
| SMS | 12% |
| Mobile Web | 6% |
| Direct Mail | 2% |
| Paid Search | 0.2% |
| Online Advertising | 0.02% |

Given the ever-expanding presence of WDs, the explosive growth of different messaging paradigms, and the advantageous response rate that is associated with messaging-based advertising, it would be desirable to be able to augment selected A2P MT messages with advertising in dynamic, intelligent, etc. ways (based on or considering inter alia the body of a message, characteristics of a MS, the current physical location of a MS' WD, a particular advertising campaign's characteristics, etc.) using inter alia bodies of flexible, extensible, and dynamically configurable material (e.g., software applications, configuration data, etc.) to significantly benefit various of the participants in a messaging ecosystem including inter alia:

1) A MS through for example reduced-cost or free messaging in exchange for receiving advertising augmented messages, the receipt of targeted advertising, etc.

2) A CP through for example incremental increases in revenue, etc.

3) An advertiser through for example an expansion over traditional advertising channels, exceptional advertisement response rates, etc.

Aspects of the present invention facilitate such dynamic augmentation in new, creative, and unconventional ways, and address various of the not insubstantial challenges that are associated with same, through an innovatory Mobile Advertising Platform (MAP).

### SUMMARY OF THE INVENTION

In one embodiment of the present invention there is provided a method for augmenting a piece of content (such as for example an A2P MT message) with a selected advertisement, where (1) the piece of content is received at a gateway, (2) various of the parameters (such as weight) of a range of campaigns are evaluated to select a target campaign, (3) one of possibly many advertisements that are associated with the target campaign is selected as a target advertisement, (4) the piece of content is augmented with aspects of the target advertisement, (5) various of the target campaign's parameters (such as weight) are adjusted, and (6) one or more repositories are updated with portions of the results of the above processing activities.

Under alternative embodiments of the present invention the evaluation step (2) above may include (a) portions of the body of the piece of content or (b) information previously provided by a MS during a registration process.

These and other features of the embodiments of the present invention, along with their attendant advantages, will be more fully appreciated upon a reading of the following detailed description in conjunction with the associated drawings.

### BRIEF DESCRIPTION OF THE DRAWINGS

The accompanying drawings, which are incorporated herein and form part of the specification, depict embodiments of the present invention and, together with the summary that was presented above and the description that may be found below, further serve to illustrate inter alia the principles, structure, and operation of such embodiments. It will be readily apparent to one of ordinary skill in the relevant art that numerous variations, modifications, alternative forms, etc. of the depicted embodiments are easily possible and indeed are within the scope of the present invention.

FIG. 1 is a diagrammatic presentation of an exemplary Messaging Inter-Carrier Vendor (MICV).

FIG. 2 illustrates one particular arrangement that is possible through aspects of the present invention.

FIG. 3 illustrates various of the exchanges or interactions that are possible under the arrangement that is presented in FIG. 2.

FIG. 4 is a high-level logical depiction of aspects of an exemplary MAP.

FIG. 5 is a mid-level logical depiction of aspects of an exemplary MAP.

FIG. 6 is a diagrammatic presentation of further aspects of an exemplary MAP.

FIG. 7 depicts an example computer system through which embodiments of aspects of the present invention may be implemented.

FIGS. 8a→8c depict illustrative messages that have been augmented by advertising as possible under aspects of the present invention.

FIG. 9 illustrates various of the exchanges that may arise during an optional registration process that may be possible under aspects of the present invention.

FIG. 10 depicts in tabular form an illustrative impression distribution that may be possible under aspects of the present invention.

FIGS. 11 and 12 depict in graphic form an illustrative impression distribution that may be possible under aspects of the present invention.

FIG. 13 depicts a portion of an illustrative Goal Engine that may be possible under aspects of the present invention.

FIG. 14 illustrates aspects of a hypothetical WorkFlow (WF) implementation that is possible through aspects of the present invention.

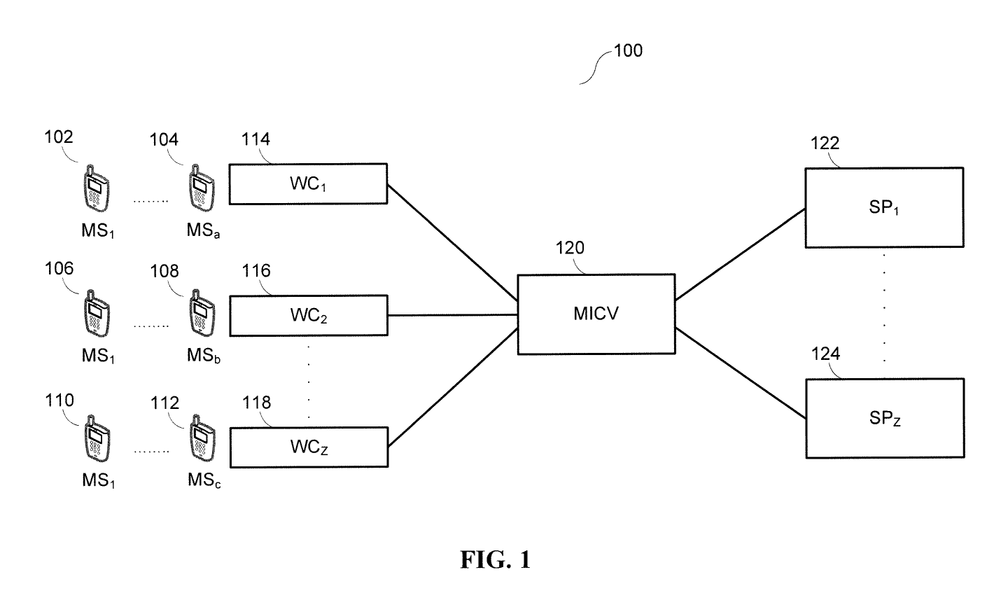

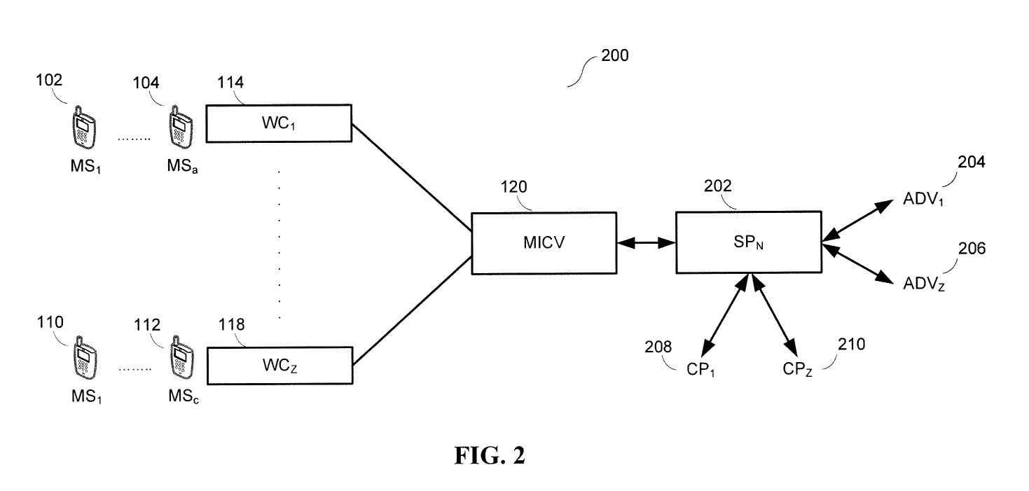

Throughout the drawings (a) like reference numbers generally indicate identical or functionally similar elements and (b) the left-most digit(s) of a reference number generally identify the drawing in which the reference number first appears. For example, in FIG. 2 reference numeral 120 would direct the reader to FIG. 1 for the first appearance of that element (i.e., element 120).

### DETAILED DESCRIPTION

It should be noted that the embodiments that are described below are merely exemplary of the invention, which may be embodied in various forms. Therefore the details that are disclosed below are not to be interpreted as limiting but merely as the basis for possibly inter alia (a) teaching one of ordinary skill in the relevant art how to make and/or use the invention and (b) the claims.

The present invention may leverage the capabilities of a centrally-located, full-featured MICV facility. Reference is made to U.S. Pat. No. 7,154,901 entitled “Intermediary network system and method for facilitating message exchange between wireless networks,” and its associated continuations, for a description of a MICV, a summary of various of the services/functions/etc. that are performed by a MICV, and a discussion of the numerous advantages that arise from same. U.S. Pat. No. 7,154,901 and its associated continuations are hereby incorporated by reference in their entirety.

As illustrated in FIG. 1 and reference numeral 100 a MICV 120 may be disposed between, possibly inter alia:

1) Multiple WCs (WC₁ 114, WC₂ 116→WC_{Z} 118) on one side, and

2) Multiple SPs (SP₁ 122→SP_{Z} 124), entities that may possibly inter alia provide a range of services/products/etc. to MSs, on the other side

and thus ‘bridges’ all of the connected entities. A MICV 120 thus, as one simple example, may offer various routing, formatting, delivery, value-add, etc. capabilities that provide, possibly inter alia:

1) A WC 114→118 (and, by extension, all of the MSs 102→104, 106→108, 110→112 that are serviced by the WC 114→118) with ubiquitous access to a broad universe of SPs 122→124, and

2) A SP 122→124 with ubiquitous access to a broad universe of WCs 114→118 (and, by extension, to all of the MSs 102→104, 106→108, 110→112 that are serviced by the WCs 114→118).

Generally speaking a MICV may have varying degrees of visibility (e.g., access, etc.) to the (MS←→MS, MS←→SP, etc.) messaging traffic:

1) A WC may elect to route just their out-of-network messaging traffic to a MICV. Under this approach the MICV would have visibility (e.g., access, etc.) to just the portion of the WC's messaging traffic that was directed to the MICV by the WC.

2) A WC may elect to route all of their messaging traffic to a MICV. The MICV may, possibly among other things, subsequently return to the WC that portion of the messaging traffic that belongs to (i.e., that is destined for a MS of) the WC. Under this approach the MICV would have visibility (e.g., access, etc.) to all of the WC's messaging traffic.

While the discussion below will include a MICV, it will be readily apparent to one of ordinary skill in the relevant art that other arrangements are equally applicable and indeed are fully within the scope of the present invention.

In the discussion below aspects of the present invention will be described and illustrated as being offered by a SP (i.e., as noted above an entity that may possibly inter alia provide a range of services/products/etc. to MSs). A SP may, for example, be realized as a third-party, an independent service bureau, an element of or within some organization (such as possibly inter alia an advertising agency, a brand, etc.), an element of a WC or a landline carrier, an element of a MICV, multiple entities (such as for example those just listed or others) or aspects of same working together, etc.

In the discussion below reference will be made to messages that are sent, for example, between a MS and a SP. As set forth below, a given ‘message’ sent between a MS and a SP may actually comprise a series of steps in which the message is received, forwarded, and routed between different entities, including possibly inter alia a MS, a WC, a MICV, and a SP. Thus, unless otherwise indicated, it will be understood that reference to a particular message generally includes that particular message as conveyed at any stage between an origination source, such as for example a MS, and an end receiver, such as for example a SP. As such, reference to a particular message generally includes a series of related communications between, for example, a MS and a WC; a WC and a MICV; a MICV and a SP; etc. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

To better understand the particulars of the present invention consider for a moment a simple hypothetical example—SP SP_{N} offers a service that has been enhanced as provided by MAP and Mary, a MS, interacts with SP_{N}'s service. Beyond SP SP_{N} and Mary our hypothetical model includes possibly inter alia the following participants:

1) Advertisers (ADVs). An ADV may inter alia create or generate advertising material (text, graphics, etc.).

2) Content Providers (CPs). A CP may inter alia create or generate content such as for example news items, traffic alerts, weather notices, travel advisories, stock quotations, advertisements, coupons, educational factoids, games, movies, songs, etc.

Among other things a MAP may allow ADVs and CPs, working individually or working together, to define an advertising campaign (a campaign), which inter alia identifies a specific number of impressions (or views) of a specific piece of advertising that are desired over an agreed upon period of time and for which a range of particulars (including possibly among other things price, terms and conditions, service level constraints, etc.) are prescribed. Within a MAP at any point in time a number of defined campaigns may exist and a given campaign may be either active or inactive.

At a high-level (and as explained in detail below) when a piece of content (e.g., an SMS, MMS, etc. message) is received from a CP a MAP may inter alia identify whether that piece of content is eligible for augmentation, identify the active campaigns that may be considered given a variety of circumstances (such as for example the nature/body/etc. of the piece of content, the different goals and objectives of each campaign, MS characteristics and preferences, etc.), select a campaign that is to be used, based on a range of parameters target (identify) a specific piece of advertising that is to be used, appropriately augment the content (e.g., the SMS, MMS, etc. message) with the piece of advertising, and update one or more repositories.

By constantly adjusting various of a campaign's parameters—to account for inter alia the current date/time, the number of messages processed, the number of impressions delivered, the desired impression distribution, etc. —a MAP may among other things ensure that each active campaign continually meets its defined objectives (and does not, for example, become under-delivered [where for example a campaign's impression target is not reached at the end of the campaign] or over-delivered [where for example a campaign's impression target is reached before the campaign is scheduled to end]).

For example, consider a simple hypothetical case where a MAP is managing inter alia five active campaigns:

| | Impression | Impressions | Days | Campaign |
|---|---|---|---|---|
| Campaign | Target | Delivered | Remaining | Weight |
| C₁ | 10,000 | 9,750 | 2 | |
| C₂ | 5,000 | 0 | 30 | |
| C₃ | 25,000 | 1,000 | 25 | |
| C₄ | 10,000 | 0 | 30 | |
| C₅ | 3,000 | 0 | 30 | |

By constantly reviewing the particulars for each active campaign a MAP may inter alia tune or adjust various of a campaign's parameters—e.g., possibly inter alia the weight that is assigned to a campaign—to ensure that the impression delivery rate for a campaign remains on-target (thus preventing the campaign from drifting to an under-delivered or an over-delivered state). The weight that is assigned to a campaign may under some circumstances be a numeric value between 0 and 1 which may subsequently be utilized by different MAP components as a piece of advertising is selected for inclusion in content (e.g., an SMS, MMS, etc. message). For example:

1) Decreasing a campaign's weight may inter alia result in advertising that is associated with the campaign being selected less frequently. This may for example allow a campaign that is near the end of its run (such as for example campaign C₁ above) to be selected less frequently and ensure inter alia that the campaign ends at (and not under or over) its impression target.

2) Increasing a campaign's weight may inter alia result in advertising that is associated with the campaign being selected more frequently. This may for example allow a campaign that is at the beginning of its run (such as for example campaign C₅ above) to be selected more frequently and ensure inter alia that the campaign ends at (and not under or over) its impression target.

FIG. 2 and reference numeral 200 depict one particular arrangement that may be possible under our hypothetical example. As indicated, all of the messaging traffic of numerous MSs (MS₁ 102→MSₐ 104 and MS₁ 110→MS_{c} 112, including Mary), serviced by various WCs (WC₁ 114→WC_{Z} 118), is exchanged with a MICV 120 and the MICV 120 is connected with SP_{N} 202 (a SP that offers, possibly inter alia, MAP). Numerous entities may interact with SP_{N} 202 including inter alia:

1) Advertisers (ADV₁ 204→ADV_{Z} 206) who may exchange information including inter alia advertising material, campaigns, etc. with SP_{N} 202, and

2) CPs (CP₁ 208→CP_{Z} 210) who may exchange information including inter alia content, campaigns, etc. with SP_{N} 202.

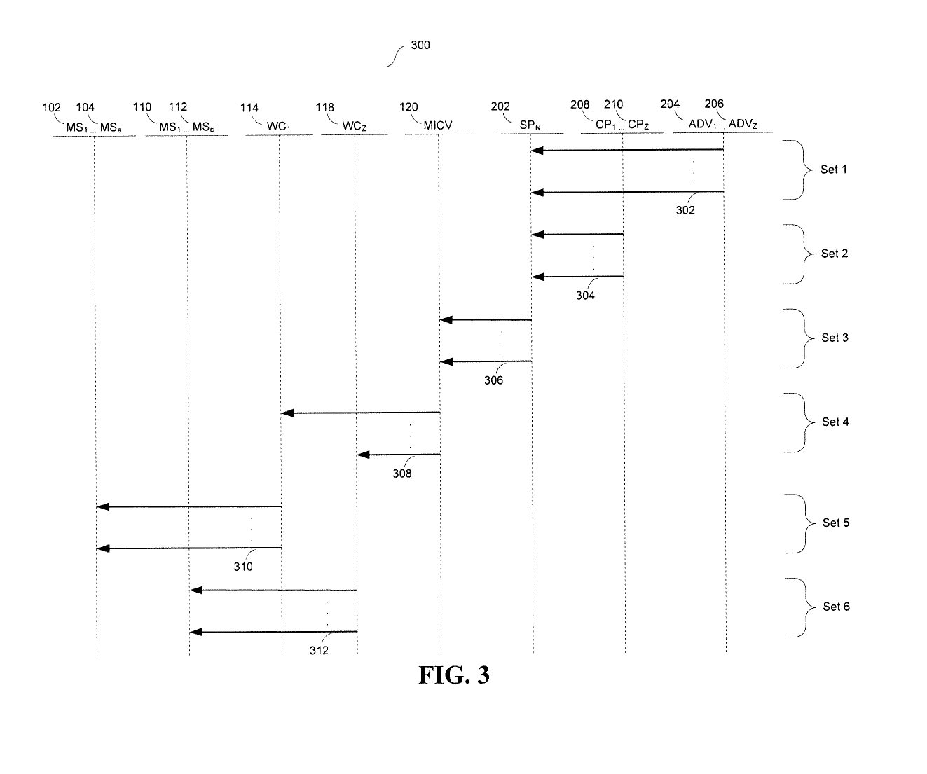

FIG. 3 and reference numeral 300 illustrate various of the exchanges or interactions that might occur under the arrangement that was illustrated in FIG. 2. Of interest and note in FIG. 3 are the following entities:

MS₁ 102→MSₐ 104. MSs who are serviced by WC WC₁ 114.

MS₁ 110→MS_{c} 112. MSs who are serviced by WC WC_{Z} 118.

WC₁ 114 and WC_{Z} 118. WCs.

MICV 120. As noted above the use of a MICV, although not required, provides significant advantages.

SP_{N} 202. A SP that offers, possibly inter alia, MAP.

CP₁ 208→CP_{Z} 210. CPs.

ADV₁ 204→ADV_{Z} 206. Advertisers.

In FIG. 3 the exchanges that are collected under the designation Set 1 represent the activities that might take place as one or more advertisers ADV₁ 204→ADV_{Z} 206 submit inter alia advertising material to SP_{N} 202 (see 302). Advertising material may consist of any combination of inter alia static text, static images, video clips, audio clips, integrated multimedia presentations, etc. and may comprise inter alia descriptive or explanatory wording; Universal Product Codes, bardcodes, or other similarly encoded representations; Uniform Resource Locators (URLs); drawings or pictures; contact details such as address, Telephone Number (TN), etc.; logos; coupons; etc.

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the submission 302 may take place any number of times, SP_{N} 202 may reply or otherwise acknowledge a submission, etc.

In FIG. 3 the exchanges that are collected under the designation Set 2 represent the activities that might take place as one or more CPs CP₁ 208→CP_{Z} 210 submit inter alia content to SP_{N} 202 (see 304). Content might consist of inter alia search results, news items, traffic alerts, weather notices, travel advisories, stock quotations, coupons, educational factoids, games, video clips, movies, audio clips, images, text, etc.

The specific exchanges that were described above (as residing under the designation Set 2) are illustrative only and it will be readily apparent to one of ordinary skill in the relevant art that numerous other exchanges are easily possible and indeed are fully within the scope of the present invention. For example, the submission 304 may take place any number of times, SP_{N} 202 may reply or otherwise acknowledge a submission, etc.

In FIG. 3 the exchanges that are collected under the designation Set 3 represent the activities that might take place as SP_{N} 202 completes a range of processing activities (described in detail below) and dispatches one or more advertising-augmented (SMS, MMS, etc.) messages (see 306).

The specific exchanges that were described above (as residing under the designation Set 3) are illustrative only and it will be readily apparent to one of ordinary skill in the relevant art that numerous other exchanges are easily possible and indeed are fully within the scope of the present invention. For example, SP_{N} 202 may dispatch messages in any combination of one or more fashions (including inter alia individually, in bulk, etc.), MICV 120 may reply or otherwise acknowledge a received message, etc.

In FIG. 3 the exchanges that are collected under the designation Set 4 represent the activities that might take place as MICV120 routes messages (based on for example a message's destination address such as a TN) and delivers messages to the appropriate WCs (see 308).

The specific exchanges that were described above (as residing under the designation Set 4) are illustrative only and it will be readily apparent to one of ordinary skill in the relevant art that numerous other exchanges are easily possible and indeed are fully within the scope of the present invention. For example, message delivery 308 may take place any number of times, a WC may reply or otherwise acknowledge a delivered message, etc.

In FIG. 3 the exchanges that are collected under the designation Set 5 and Set 6 represent the activities that might take place as a WC (WC₁ 114 and WC_{Z} 118) terminates messages to their MSs (MS₁ 102→MSₐ 104 and MS₁ 110→MS_{c} 112) (see 310 and 312).

The specific exchanges that were described above (as residing under the designations Set 5 and Set 6) are illustrative only and it will be readily apparent to one of ordinary skill in the relevant art that numerous other exchanges are easily possible and indeed are fully within the scope of the present invention. For example, the exchange 310/312 may take place any number of times, a MS may optionally reply to a message, etc.

The specific exchanges that were described above (as residing under the designation Set 1→Set 6) are illustrative only and it will be readily apparent to one of ordinary skill in the relevant art that numerous other exchanges are easily possible and indeed are fully within the scope of the present invention.

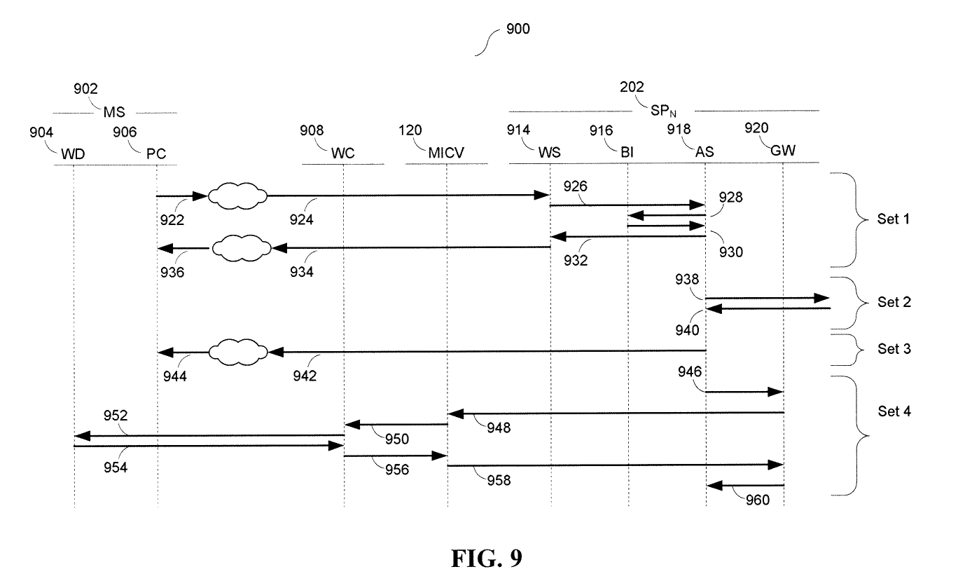

FIG. 9 and reference numeral 900 illustrate various of the exchanges or interactions that might occur under an optional registration process that may be possible under our hypothetical example. Such a registration process may be tailored (e.g., the range of information gathered, the scope of services subsequently offered, etc.) to the class of user—e.g., possibly inter alia different types, categories, etc. of users may complete different registration processes. Additionally, a registration process may be supported or offered by any combination of one or more entities (e.g., a MICV, a SP, a Third Party [3P], etc.). As well, some or all of the information that is collected during a registration process may be shared or exchanged between any combination of one or more entities (e.g., a MICV, a SP, a 3P, etc.). Thus a MS may complete a (required or optional) registration process with any number of entities and aspects of the information that is collected during a given registration process may be shared or exchanged between any number of entities. The registration process that is depicted through FIG. 9 is supported or offered by a SP (specifically by SP_{N} 202).

Of interest and note in FIG. 9 are the following entities:

MS 902 WD 904. For example, a mobile telephone, BlackBerry, PalmPilot, etc. belonging to Mary 902.

MS 902 Personal Computer (PC) 906. For example, a home, work, etc. PC of Mary 902.

WC 908. The provider of service for a WD 904 of Mary 902.

MICV 120. As noted above the use of a MICV, although not required, provides significant advantages.

SP_{N} 202 Web Server (WS) 914. A publicly-available World-Wide Web (WWW) site that is optionally provided by SP_{N} 202.

SP_{N} 202 Billing Interface (BI) 916. A single, consolidated interface that SP_{N} 202 may use to easily reach, possibly inter alia, one or more internal and/or external entities such as a credit card or debit card clearinghouse, a carrier billing system, a service bureau that provides access to multiple carrier billing systems, invoicing or billing facilities, etc.

SP_{N} 202 Application Server (AS) 918. Facilities that provide key processing, communication, etc. support.

SP_{N} 202 Gateway (GW) 920. A facility through which SP_{N} 304 may exchange possibly inter alia (SMS, MMS, etc.) messages with possibly inter alia a MICV 120.

It is important to note that while in FIG. 9 the MS 902 WD 904 and MS 902 PC 906 entities are illustrated as being adjacent or otherwise near each other, in actual practice the entities may, for example, be physically located anywhere.

In FIG. 9 the exchanges that are collected under the designation Set 1 represent the activities that might take place as Mary 902 completes a registration process with SP_{N} 202:

A) Mary 902 uses one of her PCs 906 to visit a WS 914 of SP_{N} 202 to, possibly among other things, complete a service registration process (see 922→924).

B) A WS 914 of SP_{N} 202 interacts with an AS 918 of SP_{N} 202 to, possibly among other things, commit some or all of the information that Mary 902 provided to one or more data repositories (e.g., a databases), optionally initiate a billing transaction, etc. (see 926).

C) As appropriate and as required a BI 916 completes a billing transaction (see 928→930).

D) After receiving a response from an AS 918 of SP_{N} 202 (932) a WS 914 of SP_{N} 202 responds appropriately (e.g., with the presentation of a confirmation message, etc.) (see 934→936).

The specific exchanges that were described above (as residing under the designation Set 1) are illustrative only and it will be readily apparent to one of ordinary skill in the relevant art that numerous other exchanges are easily possible and indeed are fully within the scope of the present invention. For example, the collected information may be reviewed, confirmed, etc. through one or more manual and/or automatic mechanisms. For example, the registration process may be completed through any combination of one or more channels including, inter alia, the WWW, wireless messaging (SMS, MMS, etc.), Electronic Mail (E-Mail) messages, Instant Messaging (IM), conventional mail, telephone, an Interactive Voice Response (IVR) facility, etc.

During the registration process described above a range of information may be captured from a MS including, possibly inter alia:

A) Identifying Information. For example, possibly among other things, name, address, landline and wireless TNs, E-Mail addresses, IM names/identifiers, a unique identifier and a password, etc.

B) Preference Information. For example, language (such as English, Spanish, French, etc.), quiet periods (during which for example a MS does not want to receive messages), likes and dislikes, etc.

C) Demographic Information. For example, possibly among other things, age, income, sex, political/etc. associations, frequent flyer/shopper/etc. program information, etc.

D) Billing Information. For example, the particulars (such as, possibly inter alia, name, account/routing/etc. numbers, etc.) for financial institution (bank, brokerage, etc.) accounts, credit cards, debit cards, etc. As well, possibly the selection of one or more of the different service billing models may be offered by a SP (including, inter alia, a fixed one-time charge, a recurring [monthly, etc.] fixed charge, a recurring [monthly, etc.] variable charge, a per-transaction charge, etc.) and possibly the selection of one or more of the different payment mechanisms that may be offered by a SP (including, possibly among other things, credit or debit card information, authorization to place a charge on a MS's phone bill, authorization to deduct funds from a MS' [bank, brokerage, etc.] account, etc.).

E) Other Information.

The specific pieces of information that were described above are illustrative only and it will be readily apparent to one of ordinary skill in the relevant art that numerous other pieces of information (e.g., additional Identifying Information, scheduled daily/weekly/etc. reporting desired and/or on-demand reporting desired, etc.) are easily possible and indeed are fully within the scope of the present invention.

As noted above the information that Mary provided during the registration process may be preserved in a data repository (e.g., a database) and may optionally be organized as a MS Profile.

The content of Mary's profile may be augmented by SP_{N} 202 to include, as just a few examples of the many possibilities, internal and/or external demographic, psychographic, sociological, etc. data.

As noted above, a SP's BI may optionally complete a billing transaction. The billing transaction may take any number of forms and may involve different external entities (e.g., a WC's billing system, a carrier billing system service bureau, a credit or debit card clearinghouse, a financial institution, etc.). The billing transaction may include, inter alia:

1) The appearance of a line item charge on the bill or statement that a MS receives from her WC.

2) The charging of a credit card or the debiting of a debit card.

3) The (electronic, etc.) transfer of funds.

4) The generation of an invoice, statement, etc.

In FIG. 9 the exchanges that are collected under the designation Set 2 represent the activities that might take place as SP_{N} 202 optionally coordinates, etc. with one or more external entities to, possibly among other things, secure access, exchange and/or confirm collected information, arrange to receive updates, etc. (see 938→940). During such exchanges SP_{N} 202 may employ any combination of one or more of possibly inter alia an Application Programming Interface (API), an interface layer, an abstraction layer, communication protocols, etc.

The specific exchanges that were described above (as residing under the designation Set 2) are illustrative only and it will be readily apparent to one of ordinary skill in the relevant art that numerous other exchanges (including, inter alia, updates to various of the information in a MS Profile in a SP's repository, etc.) are easily possible and indeed are fully within the scope of the present invention.

In FIG. 9 the exchanges that are collected under the designation Set 3 represent the activities that might take place as an AS 918 of SP_{N} 202 dispatches to Mary 902 one or more confirmation E-Mail messages (see 942→944).

The specific exchanges that were described above (as residing under the designation Set 3) are illustrative only and it will be readily apparent to one of ordinary skill in the relevant art that numerous other exchanges (including, inter alia, the dispatch of multiple E-mail messages [i.e., multiple instances of the sequence 942→944], the reply by Mary 902 to a received E-mail message, etc.) are easily possible and indeed are fully within the scope of the present invention.

In FIG. 9 the exchanges that are collected under the designation Set 4 represent the activities that might take place as an AS 918 of SP_{N} 202 dispatches one or more confirmation SMS, MMS, etc. messages to a WD 904 of Mary 902 (946→952) and Mary 902 optionally replies or responds to the message(s) (954→960). Of interest and note are:

1) In the instant example the messages are shown traversing a MICV 120.

2) SP_{N} 202 may employ a Short Code (SC) or a regular TN as its source address (and to which it would ask users of its service to direct any reply messages). While the abbreviated length of a SC (e.g., five digits for a SC administered by Neustar uder the Common Short Code [CSC] program) incrementally enhances the experience of a MS 902 (e.g., Mary 902 need remember and enter only a few digits as the destination address of a reply message) it also, by definition, constrains the universe of available SCs thereby causing each individual SC to be a limited or scarce resource and raising a number of SC/CSC management, etc. issues. A description of a common (i.e., universal) short code environment may be found in pending U.S. patent application Ser. No. 10/742,764 entitled “Universal Short Code administration facility.”

The specific exchanges that were described above (as residing under the designation Set 4) are illustrative only and it will be readily apparent to one of ordinary skill in the relevant art that numerous other exchanges are easily possible and indeed are fully within the scope of the present invention. For example, either of the sequences 946→952 or 954→960 may be repeated any number of times, Mary 902 may need to include some portion of one or more received confirmation E-Mail messages (see 942→944) in her reply/response (954→960), etc.

The Set 1, Set 2, Set 3, and Set 4 exchanges that were described above are illustrative only and it will be readily apparent to one of ordinary skill in the relevant art that numerous other exchanges are easily possible and indeed are fully within the scope of the present invention. For example, possibly inter alia, aspects of the registration information that was described above may subsequently be managed (e.g., existing information may be edited or removed, new information may be added, etc.) through any combination of one or more channels including, inter alia, a WWW facility, wireless messaging (SMS, MMS, etc.), E-Mail messages, IM exchanges, conventional mail, telephone, IVR facilities, etc. Additionally, aspects of the registration information may be exchanged with one or more entities (such as possibly inter alia a 3P such as a financial institution, a retail establishment, an on-line retailer, an employer, a utility company, etc.; another SP; etc.).

The confirmation, response, etc. message(s) that were described above may optionally contain additional information, such as inter alia an informational element (e.g., a relevant or applicable factoid, etc.) or promotional material. The additional information may be selected statically (e.g., all messages are injected with the same additional information), randomly (e.g., a message is injected with additional information that is randomly selected from a pool of available information), location-based (i.e., a message is injected with additional information that is selected from a pool of available information based on the current physical location of the recipient of the message as derived from, as one example, a Location-Based Service [LBS], Global Positioning System [GPS], etc. facility), or etc.

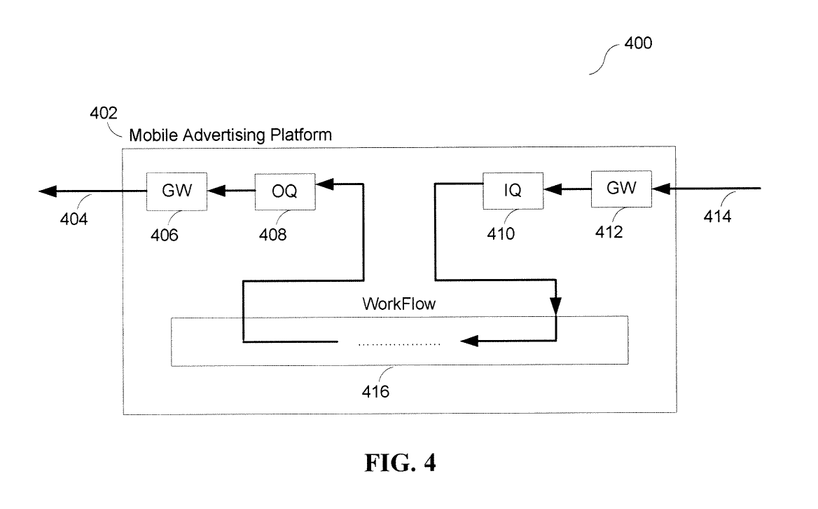

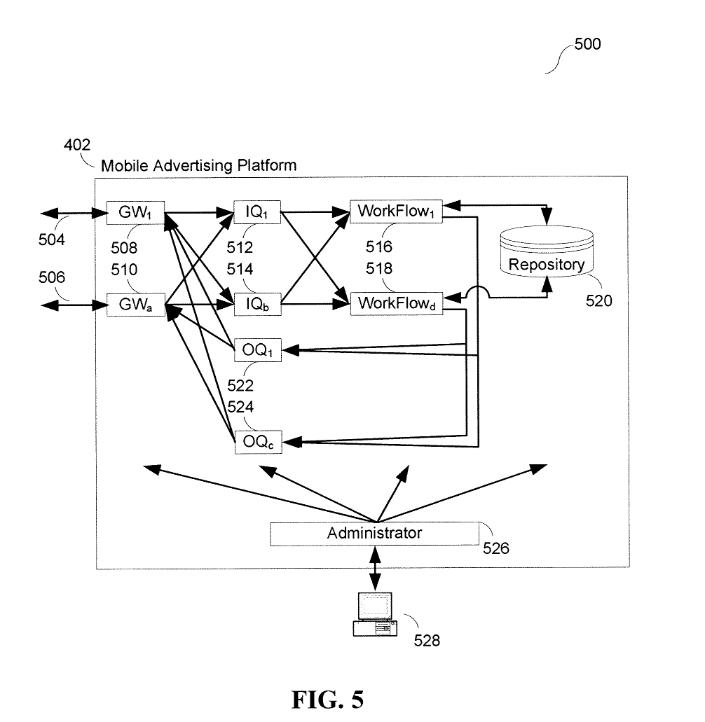

FIG. 4 and reference numeral 400 present a high-level logical depiction of aspects of an exemplary MAP 402 that may support inter alia various of the exchanges that were presented in FIG. 3 and FIG. 9. As depicted, a MAP 402 may include among other elements a GW 412 through which incoming material (including possibly inter alia advertising material, content, etc.) may be received 414, an Incoming Queue (IQ) 410 on to which the received material may be deposited, a WF 416 wherein a range of processing activities (described in detail below) may be completed, an Outgoing Queue (OQ) 408 on to which processed material (including possibly inter alia advertising augmented messages) may be deposited, and a GW 406 through which processed material may be dispatched 404.

The specific components and the particular component arrangement that were described above are illustrative only and it will be readily apparent to one of ordinary skill in the relevant art that numerous other components and component arrangements are easily possible and indeed are fully within the scope of the present invention.

FIG. 5 and reference numeral 500 follow on from FIG. 4 and present a mid-level (i.e., slightly lower-level) logical depiction of an exemplary MAP 402. In support of various goals such as operational performance, redundancy, scalability, dynamic configuration, etc. the illustrated MAP 402 contains: Gateways (GW₁ 508→GWₐ 510 in the diagram), Incoming Queues (IQ₁ 512→IQ_{b} 514 in the diagram), WorkFlows (WorkFlow₁ 516→WorkFlow_{d} 518 in the diagram), Repository 520, Outgoing Queues (OQ₁ 522→OQ_{c} 524 in the diagram), and an Administrator 526.

A dynamically updateable set of one or more Gateways (GW₁ 508→GWₐ 510 in the diagram) handle incoming material (including possibly inter alia advertising material, content, etc.) 504→506 and outgoing material (including possibly inter alia advertising augmented messages) 504→506. A GW may support the receipt of incoming material 504→506 and the dispatch of outgoing material 504→506 via any combination of one or more of the available public and/or proprietary transport-level and application-level communication paradigms including possibly inter alia Transmission Control Protocol (TCP)/IP, Signaling System Seven (SS7), Short Message Peer-to-Peer (SMPP), Computer Interface to Message Distribution (CIMD), External Machine Interface (EMI)/Universal Computer Protocol (UCP), SS7 Mobile Application Part, MM4, MM7, HyperText Transfer Protocol (HTTP), Extensible Markup Language (XML), API, etc.

Incoming material 504→506 may be accepted and deposited on an intermediate or temporary Incoming Queue (IQ₁ 512→IQ_{b} 514 in the diagram) for subsequent processing. Outgoing material may be removed from an intermediate or temporary Outgoing Queue (OQ₁ 522→OQₙ 524 in the diagram) and then dispatched 504→506.

Thus a dynamically updateable set of one or more Incoming Queues (IQ₁ 512→IQ_{b} 514 in the diagram) and a dynamically updateable set of one or more Outgoing Queues (OQ₁ 522→OQ_{c} 524 in the diagram) operate as intermediate or temporary buffers for incoming material 504→506 and outgoing material 504→506.

A dynamically updateable set of one or more WorkFlows (WorkFlow₁ 516→WorkFlow_{d} 518 in the diagram) possibly inter alia remove incoming material 504→506 from an intermediate or temporary Incoming Queue (IQ₁ 512→IQ_{b} 514 in the diagram), perform all of the required processing operations (described in detail below), and deposit outgoing material on an intermediate or temporary Outgoing Queue (OQ₁ 522→OQ_{c} 524 in the diagram). The WorkFlow component will be described more fully below.

The Repository 520 that is depicted in FIG. 5 is a logical representation of the possibly multiple physical repositories that may be implemented to support, inter alia, configuration, campaigns, advertising material, content, monitoring, alerting, tracking, etc. information. The physical repositories may be implemented through any combination of conventional Relational Database Management Systems (RDBMSs) such as Oracle, through Object Database Management Systems (ODBMSs), through in-memory Database Management Systems (DBMSs), or through any other equivalent facilities.

An Administrator 526 that is depicted in FIG. 5 may provide management or administrative control over all of the different components of a MAP 402 through, as one example, a WWW-based interface 528. It will be readily apparent to one of ordinary skill in the relevant art that numerous other interfaces (e.g., a data feed, an API, etc.) are easily possible.

Through flexible, extensible, and dynamically updatable configuration information a WorkFlow component (WorkFlow₁ 516→WorkFlow_{d} 518 in FIG. 5) may be quickly and easily realized to support any number of activities. For example, WorkFlows might be configured to support a registration process; to support interactions with external entities such as inter alia advertisers, content providers, etc.; to support various internal processing steps (as described below); to support the generation and dispatch of confirmation, etc. messages; to support various billing transactions; to support the generation of scheduled and/or on-demand reports; etc. The specific WorkFlows that were just described are exemplary only; it will be readily apparent to one of ordinary skill in the relevant art that numerous other WorkFlow arrangements, alternatives, etc. are easily possible.

As noted above, a MAP may maintain a repository (520 in FIG. 5) and may in such a repository preserve aspects of all administrative, processing, messaging, etc. activities. Among other things such a repository may be used to support:

1) Scheduled (e.g., daily, weekly, etc.) and/or on-demand reporting with report results delivered through SMS, MMS, etc. messages; through E-Mail; through a WWW-based facility; etc.

2) Scheduled and/or on-demand data mining initiatives (possibly leveraging or otherwise incorporating one or more external data sources) with the results of same presented through Geographic Information Systems (GISs), visualization, etc. facilities and delivered through SMS, MMS, etc. messages; through E-Mail; through a WWW-based facility; etc.

The specific components and the particular component arrangement that were described above are illustrative only and it will be readily apparent to one of ordinary skill in the relevant art that numerous other components and component arrangements are easily possible and indeed are fully within the scope of the present invention.

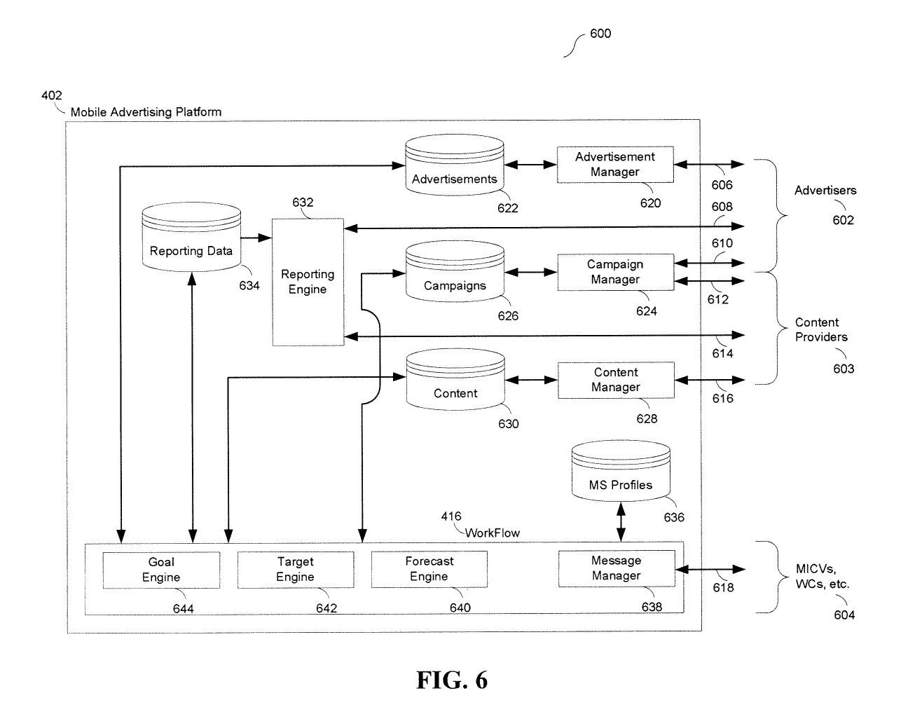

FIG. 6 and reference numeral 600 depict additional components that may be possible within a MAP 402 including:

1) An Advertisement Manager 620 that may inter alia allow Advertisers 602 to submit, edit, manage, etc. 606 advertising material with such material preserved in an Advertisements repository 622.

2) A Campaign Manager 624 that may inter alia allow Advertisers 602 and Content Providers 603 to define, change, cancel, update, manage, etc. 610/612 campaigns with such material preserved in a Campaigns repository 626.

3) A Content Manager 628 that may inter alia allow Content Providers 603 to submit, edit, manage, etc. 616 content with such material preserved in an Content repository 630.

4) A Reporting Engine 632 through which inter alia Advertisers 602 and Content Providers 603 may 608/614 request, run, view, etc. various reports with associated and supporting data preserved in a Reporting Data repository 634.

5) A repository of MS Profiles 636 (see for example the registration process that was discussed above).

6) A Goal Engine 644 that inter alia (a) may be WF-based 416, (b) may estimate the future performance of a campaign (based on possibly among other things past performance, operating bounds, desired distribution model, etc.) and adjust various campaign constraints, parameters, etc. (inter alia a campaign's weight) so that a campaign may best achieve a set of defined objectives (such as for example a certain number of impressions over a specified time period, etc.), (c) may be run continually, at specified intervals (e.g., every minute, every 10 minutes, every hour, etc.), or on-demand as needed, and (d) may update one or more repositories (such as Campaigns 626, etc.).

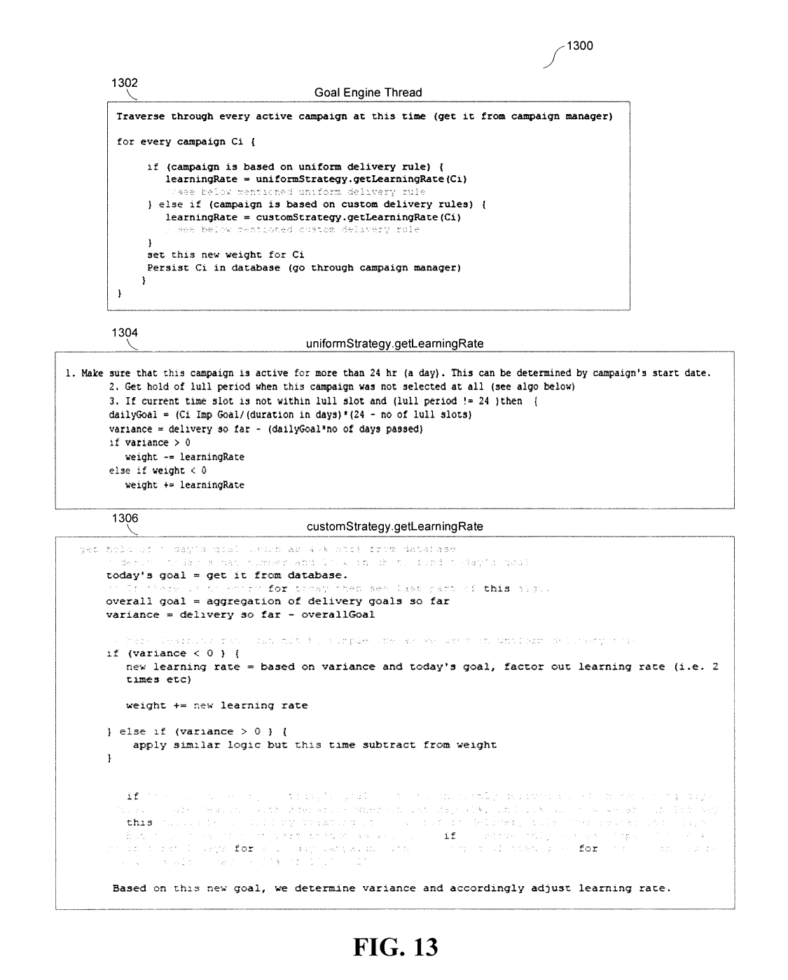

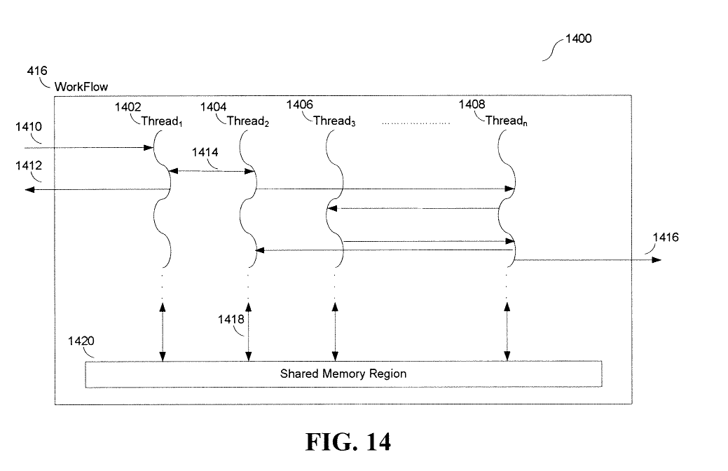

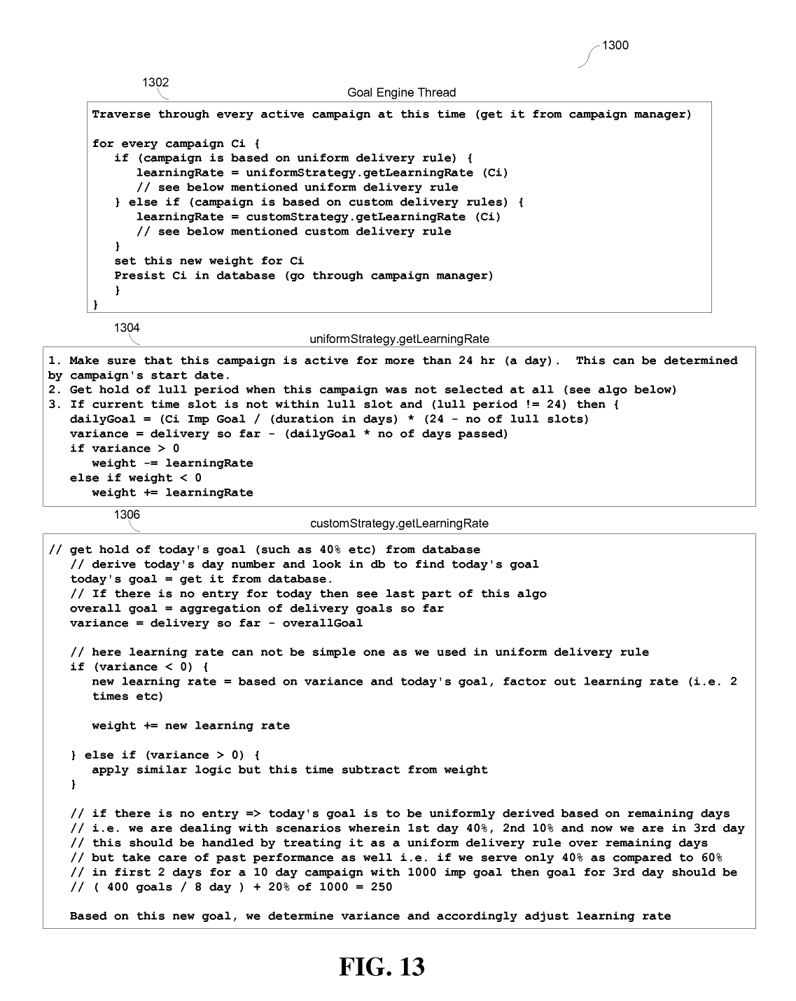

For purposes of illustration, FIG. 13 and reference numeral 1300 present snippets of pseudo-code (1302/1304/1306) that might be associated with a thread of execution within a hypothetical Goal Engine.

As noted above, a Goal Engine 644 may as it performs its work draw upon inter alia a collection of operating bounds. Such bounds may for example request that a campaign be ‘shaped’ in different ways (e.g., 50% of the total impressions should be delivered during days 1→3 of the campaign; 40% of the total impressions should be delivered during days 4→20 of the campaign; and 10% of the total impressions should be delivered during days 21→30 of the campaign).

7) A Target Engine 642 that inter alia (a) may be WF-based 416, (b) may target (identify) a specific piece of available advertising based on various parameters, and (c) may update one or more repositories (such as Reporting Data 634, Campaigns 626, etc.).

The parameters that were noted above may include inter alia the body of a piece of content (e.g., an SMS, MMS, etc. message), characteristics of a MS (as retrieved for example from a repository of MS Profiles 636), the current physical location of a MS' WD, a particular advertising campaign's characteristics, etc. Additionally, a specific piece of advertising may be selected randomly from all available advertising.

8) A Forecast Engine 640 that inter alia (a) may be WF-based 416, (b) may manage an inventory of advertising material and possibly among other things identify available advertising based on for example past history, (c) may be run continually, at specified intervals (e.g., every minute, every 10 minutes, every hour, etc.), or on-demand as needed, and (d) may update one or more repositories (such as Advertisements 622, etc.).

9) A Message Manager 638 that inter alia (a) may be WF-based 416, (b) may communicate or interact 618 with various messaging entities such as for example MICVs, WCs, etc. 604, (c) may leverage one or more engines (such as for example a Target Engine 642, etc.) to secure an appropriate piece of advertising material and augment a message with that advertising material, and (d) may update one or more repositories (such as Reporting Data 634, etc.).

For purposes of illustration a Message Manager 638 may inter alia:

1) Receive a piece of content (e.g., an SMS, MMS, etc. message).

2) Extract, edit, validate, etc. various data elements from the piece of content including possibly inter alia the source address (such as TN), the body, etc.

3) Identify (based on inter alia a flexible, extensible, and dynamically configurable body of rules, logic, etc.) whether the received piece of content is eligible for augmentation.

4) Identify (based on inter alia the nature/body/etc. of the piece of content, various MS characteristics/preferences/etc. [as retrieved for example from a repository of MS Profiles 636 using the source address], the different goals and objectives of each campaign, etc.) one or more active campaigns that may be considered.

5) Select (based on inter alia a campaign's weight, etc.) a specific campaign.

6) Identify (for example randomly, etc.) a specific piece of advertising that is associated with the selected campaign.

7) Appropriately augment any combination of one or more of the beginning, the middle/body, or the end of the content (e.g., the SMS, MMS, etc. message) with the selected piece of advertising.

The catalog of processing steps, activities, etc. that was described above is illustrative only and it will be readily apparent to one of ordinary skill in the relevant art that numerous other processing steps, activities, etc. are easily possible and indeed are fully within the scope of the present invention.

As noted above, one or more of a Goal Engine 644, a Target Engine 642, a Forecast Engine 640, and a Message Manager 638, possibly among other MAP components, may be WF-based. For purposes of illustration FIG. 14 and reference numeral 1400 depict aspects of a WF environment 416 wherein possibly inter alia:

1) A dynamically adjustable number of threads (Thread₁ 1402, Thread₂ 1404, Thread₃ 1406, . . . Threadₙ 1408) may be inter alia created, started, allowed to operate or execute, quiesced, stopped, destroyed, etc. under control of for example the WF environment 416. Among other things one or more threads may for example realize aspects of a MAP component (such as inter alia a Goal Engine 644, a Target Engine 642, etc.) and/or a single thread may for example realize aspects of one or more MAP components (such as inter alia a Goal Engine 644, a Target Engine 642, etc.).

2) Other MAP components may communicate, interact, etc. with various of the threads (Thread₁ 1402→Threadₙ 1408) (see for example 1410, 1412, and 1416).

3) Various of the threads (Thread₁ 1402→Threadₙ 1408) may among themselves communicate, interact, etc. (see for example 1414).

4) Various of the threads (Thread₁ 1402→Threadₙ 1408) may communicate, interact, etc. with inter alia a Shared Memory Region (1420) (see for example 1418).

Among other things a Goal Engine 644, a Target Engine 642, and a Forecast Engine 640, working individually or in any combination, may initially define and optionally subsequently re-define (e.g., continuously, every minute, every hour, once a day, once a week, at certain ‘impressions delivered’ thresholds, etc.) for a particular campaign various impression distribution goals, campaign parameters (such as for example campaign weight), etc. For example, a Forecast Engine 640 may inter alia develop a forecast of what content (e.g., SMS, MMS, etc. message) traffic may look like during some future time period. Such a forecast may inter alia be used to verify that various of a campaign's parameters (such as for example campaign weight), that may be employed by inter alia a Goal Engine 644, are sufficient, appropriate, etc. If a campaign parameter is found to need adjustment then inter alia the parameter may be appropriately changed and the verification process may be repeated (to confirm the desired results). A Message Manager 638, possibly among other components, may utilize such impression distribution goals, campaign parameters, etc. as various processing activities are completed. It will be readily apparent to one of ordinary skill in the relevant art that during any of the definition, forecasting, verification, etc. activities any number of techniques (including inter alia Markov-Chain Monte Carlo methods, other stochastic or random methods, non-random sampling methods, etc.) may be employed, either individually or in combination.

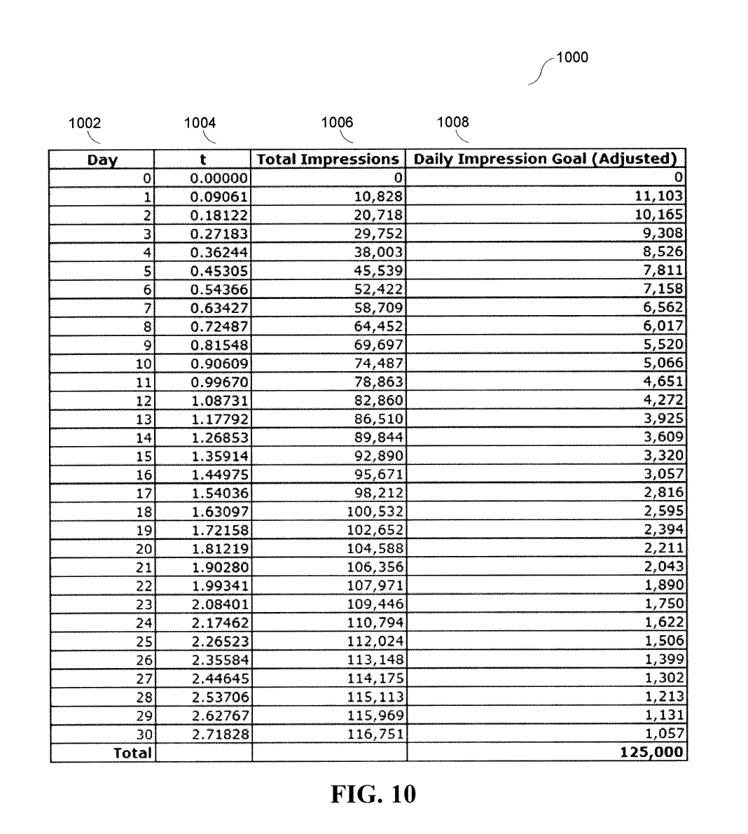

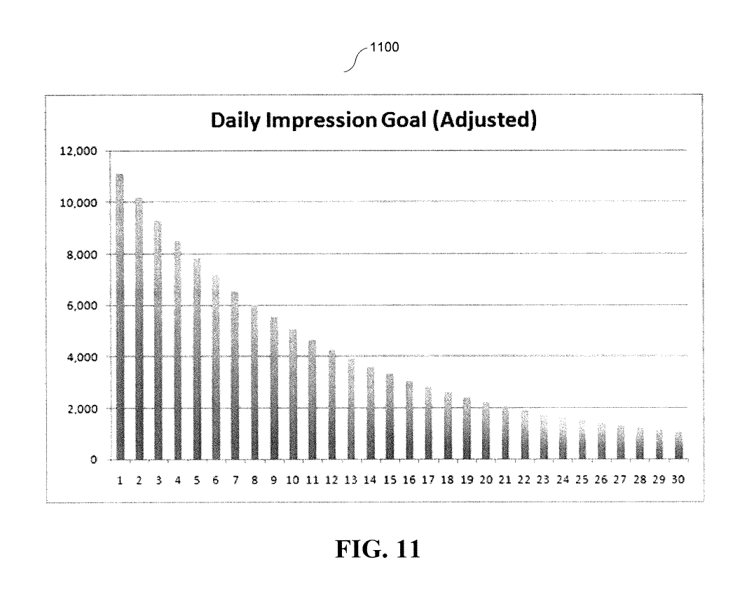

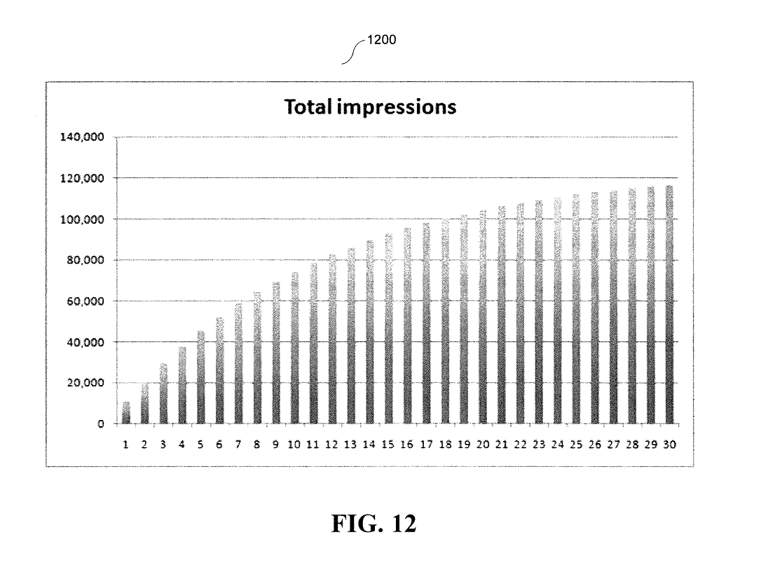

For purposes of illustration FIG. 10 and reference numeral 1000 depict in tabular form the daily impression goals 1008 and the total impressions 1006 for a hypothetical campaign that (1) runs or spans 30 calendar days 1002 and (2) results in a total of 125,000 impressions. FIG. 11 and reference numeral 1100 provide a graphic depiction of the daily impression goals 1008 and FIG. 12 and reference numeral 1200 provide a graphic depiction of the total impressions 1006.

The daily impression goals 1008 under this hypothetical campaign are arrived at through the distribution:

DailyImpressionGoal(day)=t*(−(ê(−t))+1)

where the intermediate value t 1004 is calculated as:

(day*e/NumberOfDays)

with e is the standard mathematical constant 2.7182818 . . . and in the instant example NumberOfDays is 30 (see 1002).

It will be readily apparent to one of ordinary skill in the relevant art that numerous other distributions (such as inter alia random, custom [as defined for example by an ADV], normal/Gaussian, Poisson, sigmoidal, power or logarithmic, a combination of two or more different distributions, etc.) are easily possible and indeed are fully within the scope of the present invention.

By constantly adjusting various of a campaign's parameters (such as for example a campaign's weight) to account for inter alia the current date/time, the number of messages processed, the number of impressions delivered, the desired impression distribution, etc. a MAP may among other things ensure that each active campaign continually meets its defined objectives (and does not, for example, become under-delivered or over-delivered).

For FIG. 6 each of the different exchanges that were discussed above (606, 608, 610, 612, 614, 616, and 618) may be realized through any combination of one or more of the available public and/or proprietary transport-level and application-level communication paradigms including possibly inter alia TCP/IP, SS7, SMPP, CIMD, EMI/UCP, SS7 Mobile Application Part, MM4, MM7, HTTP, XML, API, etc.

The specific components and the particular component arrangement that were described above are illustrative only and it will be readily apparent to one of ordinary skill in the relevant art that numerous other components and component arrangements are easily possible and indeed are fully within the scope of the present invention.

As well, the catalog of processing steps, activities, etc. that was described above is illustrative only and it will be readily apparent to one of ordinary skill in the relevant art that numerous other processing steps, activities, etc. are easily possible and indeed are fully within the scope of the present invention.

To continue with our hypothetical example . . . as Mary goes about her daily activities there may arise numerous instances where she engages in an activity that results in one or more A2P MT messages being delivered to her WD. For example:

1) Mary may wish to determine the balance of one of her (bank, brokerage, credit card, etc.) accounts, resulting in one or more A2P MT messages (containing account balance information) being delivered to her WD.

2) Mary may wish to complete the payment portion of a purchase (from, for example, an on-line retailer, etc.) resulting in one or more A2P MT messages (containing transaction, confirmation, etc. information) being delivered to her WD.

3) Marry may issue a search or a query (such as by sending a message containing a search request to the SC 46645 [GOOGL on a telephone keypad]) resulting in one or more A2P MT messages (containing search results) being delivered to her WD.

4) Mary may receive an update (such as a news item, a traffic alert, a weather notice, a travel advisory, a stock quotation) from a service to which she has subscribed, resulting in one or more A2P MT messages (containing various service-specific information) being delivered to her WD.

The specific examples that were cataloged above are illustrative only and it will be readily apparent to one of ordinary skill in the relevant art that numerous other examples are easily possible and indeed are fully within the scope of the present invention.

Through MAP any of the A2P MT messages that were identified above may be augmented with advertising. For purposes of illustration:

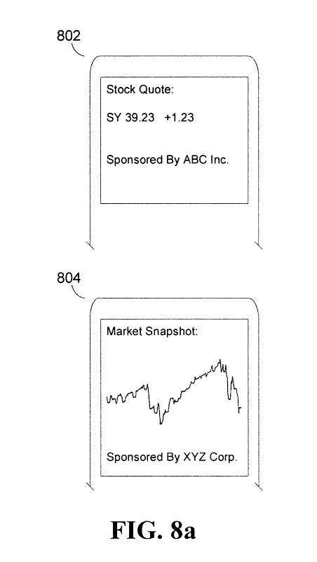

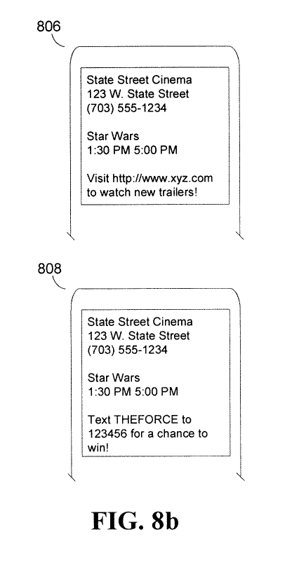

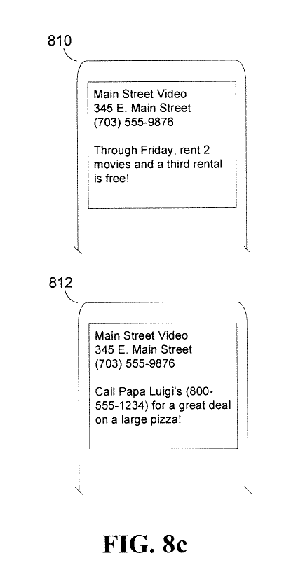

1) Mary employs her WD to request a stock market update. The results of Mary's request may be returned by a CP (such as for example MarketWatch, E-Trade, etc.) as a (SMS, MMS, etc.) message (i.e., content) at which time MAP may possibly inter alia determine the eligibility of the message for advertising, identify an available advertisement (based on one or more of for example the particulars of Mary's request and the body of the results returned by a CP, the campaigns that are active, the campaigns whose impression delivery goals/objectives/etc. best meet various criteria, information from Mary's MS Profile, etc.), appropriately augment the message with the identified advertisement, and update one or more internal repositories. Reference numeral 802 in FIG. 8a depicts a possible SMS message and reference numeral 804 in FIG. 8a depicts a possible MMS message.

2) Mary employs her WD to request a movie showing time. The results of Mary's request may be returned by a CP (such as for example a movie theater, Fandago, etc.) as a (SMS, MMS, etc.) message (i.e., content) at which time MAP may possibly inter alia determine the eligibility of the message for advertising, identify an available advertisement (based on one or more of for example the particulars of Mary's request and the body of the results returned by a CP, the campaigns that are active, the campaigns whose impression delivery goals/objectives/etc. best meet various criteria, information from Mary's MS Profile, etc.), appropriately augment the message with the identified advertisement, and update one or more internal repositories. Reference numeral 806 in FIG. 8b depicts one possible approach (under which an embedded URL is included for Mary to optionally select/click) and reference numeral 808 in FIG. 8b depicts an alternate approach (under which Mary is asked to address an SMS message, containing certain text, to a particular SC).

3) Mary employs her WD to search for a video rental store. The results of Mary's request may be returned by a CP (such as for example a video rental store, Google, etc.) as a (SMS, MMS, etc.) message (i.e., content) at which time MAP may possibly inter alfa determine the eligibility of the message for advertising, identify an available advertisement (based on one or more of for example the particulars of Mary's request and the body of the results returned by a CP, the campaigns that are active, the campaigns whose impression delivery goals/objectives/etc. best meet various criteria, information from Mary's MS Profile, etc.), appropriately augment the message with the identified advertisement, and update one or more internal repositories. Reference numeral 810 in FIG. 8c depicts one possible approach (under which an announcement, a coupon, etc. is included) and reference numeral 812 in FIG. 8c depicts an alternate approach (under which contact information [such as a TN] for a third-party is included).

The catalog of processing steps, activities, etc. that was described above is illustrative only and it will be readily apparent to one of ordinary skill in the relevant art that numerous other processing steps, activities, etc. are easily possible and indeed are fully within the scope of the present invention. For example, a MAP implementation may:

1) Allow a CP to optionally identify or designate where in their content advertising may be placed. For example, such a designation may take the form of one or more sets of tags (e.g., <Adv></Adv>) within the content.

2) As it identifies an available advertisement for inclusion in a (SMS, MMS, etc.) message incorporate any combination of one or more of for example information gathered from a biometric recognition device, information gathered from a camera, MS login-in credentials (such as identification and password), information gathered from an Infrared (IR) device, information gathered from a Near Field Communication (NFC) device, etc. and conveyed to a MAP implementation through any number of possible channels.

3) Support different impression distribution paradigms. One particular impression distribution was discussed above. It will be readily apparent to one of ordinary skill in the relevant art that numerous other impression distributions—including inter alia random, custom (e.g., as defined by an ADV), normal/Gaussian, Poisson, a combination of two or more different distributions, etc. —are possible and indeed are fully within the scope of the present invention.

4) Facilitate a forum within which a CP may optionally identify a volume of content such as (SMS, MMS, etc.) messages that is available by hour, by day, etc. and for which advertisers may optionally bid (e.g., on different subsets of the volume of messages) with a MAP implementation moderating such activities (e.g., auctions).

5) Support variable augmentation models. In the discussion above a message was augmented with advertising through the addition, insertion, etc. of that advertising to/in the message (M₁). It will be readily apparent to one of ordinary skill in the relevant art that numerous other augmentation approaches are easily possible. For example, once selected a piece of advertising could be sent to a MS as its own separate (SMS, MMS, etc.) message (M₂) and not for example added to, inserted in, etc. message M₁.

6) Support language, and perhaps other attribute, localization based on possibly inter alia information from a MS Profile, information on the current physical location of a MS' WD, etc.

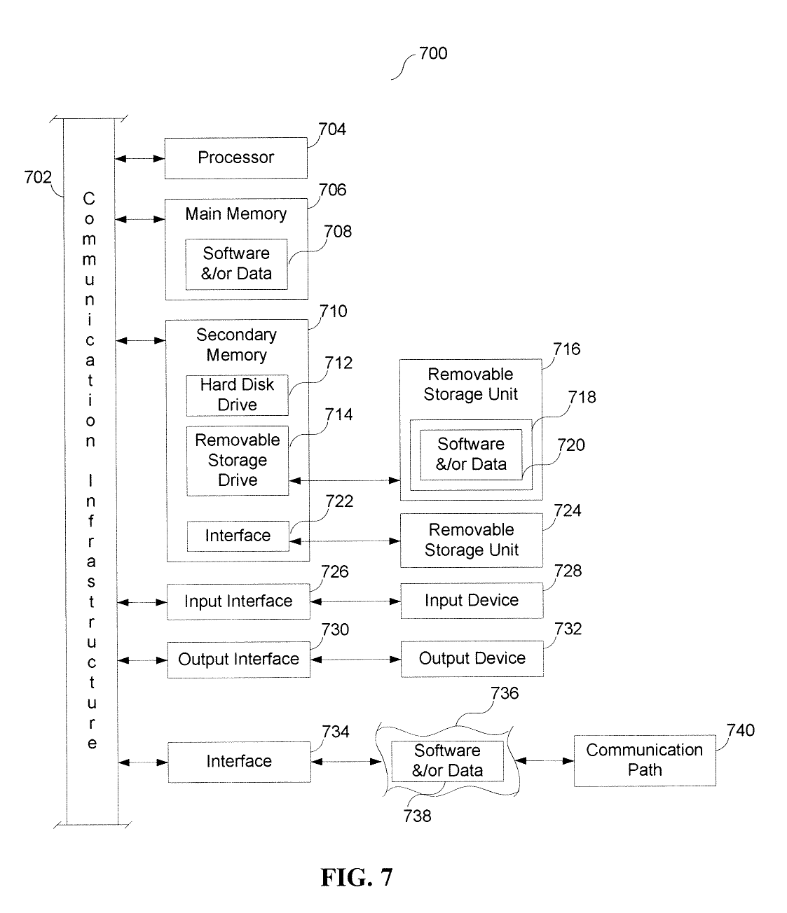

Various aspects of the present invention can be implemented by software, firmware, hardware, or any combination thereof. FIG. 7 illustrates an example computer system 700 in which the present invention, or portions thereof, (such as described above under paragraphs 41-50 and paragraphs 54-196) can be implemented as computer-readable code. Various embodiments of the invention are described in terms of this example computer system 700. After reading this description, it will become apparent to a person skilled in the relevant art how to implement the invention using other computer systems and/or computer architectures.

Computer system 700 includes one or more processors, such as processor 704. Processor 704 can be a special purpose processor or a general purpose processor. Processor 704 is connected to a communication infrastructure 702 (for example, a bus or a network).

Computer system 700 also includes a main memory 706, preferably Random Access Memory (RAM), containing possibly inter alia computer software and/or data 708.

Computer system 700 may also include a secondary memory 710. Secondary memory 710 may include, for example, a hard disk drive 712, a removable storage drive 714, a memory stick, etc. A removable storage drive 714 may comprise a floppy disk drive, a magnetic tape drive, an optical disk drive, a flash memory, or the like. A removable storage drive 714 reads from and/or writes to a removable storage unit 716 in a well known manner. A removable storage unit 716 may comprise a floppy disk, magnetic tape, optical disk, etc. which is read by and written to by removable storage drive 714. As will be appreciated by persons skilled in the relevant art(s) removable storage unit 716 includes a computer usable storage medium 718 having stored therein possibly inter alia computer software and/or data 720.

In alternative implementations, secondary memory 710 may include other similar means for allowing computer programs or other instructions to be loaded into computer system 700. Such means may include, for example, a removable storage unit 724 and an interface 722. Examples of such means may include a program cartridge and cartridge interface (such as that found in video game devices), a removable memory chip (such as an Erasable Programmable Read-Only Memory [EPROM], or Programmable Read-Only Memory [PROM]) and associated socket, and other removable storage units 724 and interfaces 722 which allow software and data to be transferred from the removable storage unit 724 to computer system 700.

Computer system 700 may also include an input interface 726 and a range of input devices 728 such as, possibly inter alia, a keyboard, a mouse, etc.

Computer system 700 may also include an output interface 730 and a range of output devices 732 such as, possibly inter alia, a display, one or more speakers, etc.

Computer system 700 may also include a communications interface 734. Communications interface 734 allows software and/or data 738 to be transferred between computer system 700 and external devices. Communications interface 734 may include a modem, a network interface (such as an Ethernet card), a communications port, a Personal Computer Memory Card International Association (PCMCIA) slot and card, or the like. Software and/or data 738 transferred via communications interface 734 are in the form of signals 736 which may be electronic, electromagnetic, optical, or other signals capable of being received by communications interface 734. These signals 736 are provided to communications interface 734 via a communications path 740. Communications path 740 carries signals and may be implemented using wire or cable, fiber optics, a phone line, a cellular phone link, a Radio Frequency (RF) link or other communications channels.

As used in this document, the terms “computer program medium,” “computer usable medium,” and “computer readable medium” generally refer to media such as removable storage unit 716, removable storage unit 724, and a hard disk installed in hard disk drive 712. Signals carried over communications path 740 can also embody the logic described herein. Computer program medium and computer usable medium can also refer to memories, such as main memory 706 and secondary memory 710, which can be memory semiconductors (e.g. Dynamic Random Access Memory [DRAM] elements, etc.). These computer program products are means for providing software to computer system 700.

Computer programs (also called computer control logic) are stored in main memory 706 and/or secondary memory 710. Computer programs may also be received via communications interface 734. Such computer programs, when executed, enable computer system 700 to implement the present invention as discussed herein. In particular, the computer programs, when executed, enable processor 704 to implement the processes of aspects of the present invention, such as the steps discussed above under paragraphs 41-50 and paragraphs 54-196. Accordingly, such computer programs represent controllers of the computer system 700. Where the invention is implemented using software, the software may be stored in a computer program product and loaded into computer system 700 using removable storage drive 714, interface 722, hard drive 712 or communications interface 734.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory [CD-ROM] disks, Zip disks, tapes, magnetic storage devices, optical storage devices, Microelectromechanical Systems [MEMS], nanotechnological storage device, etc.), and communication mediums (e.g., wired and wireless communications networks, local area networks, wide area networks, intranets, etc.).

It is important to note that while aspects of the discussion that was presented above referenced the use of SCs and TNs it will be readily apparent to one of ordinary skill in the relevant art that other address identifiers (such as, for example, Session Initiation Protocol [SIP] Address, URL, etc.) are equally applicable and, indeed, are fully within the scope of the present invention.

The discussion that was just presented frequently referenced two specific wireless messaging paradigms—SMS and MMS. Those paradigms potentially offer an incremental advantage over other paradigms in that native support for SMS and/or MMS is commonly found on a WD that a potential MS would be carrying. However, it is to be understood that it would be readily apparent to one of ordinary skill in the relevant art that numerous other paradigms (such as, for example, IMS, IM, E-Mail, Wireless Application Protocol [WAP], etc.) are fully within the scope of the present invention.

It is important to note that the hypothetical example that was presented above, which was described in the narrative and which was illustrated in the accompanying figures, is exemplary only. It is not intended to be exhaustive or to limit the invention to the specific forms disclosed. It will be readily apparent to one of ordinary skill in the relevant art that numerous alternatives to the presented example are easily possible and, indeed, are fully within the scope of the present invention. The scope of the invention is to be defined only by the claims appended hereto, and by their equivalents.

In describing representative embodiments of the present invention the specification may have presented the method and/or the process of aspects of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or the process of aspects of the present invention should not be limited to the performance of their steps in the order written; one skilled in the art will readily appreciate that the sequences may be varied and still remain within the spirit and scope of the present invention.

The following acronyms are employed in this disclosure:

| Acronym | Meaning |
|---|---|
| A2P | Application -to-Peer |
| ADV | Advertiser |
| API | Application Programming Interface |
| AS | Application Server |
| BI | Billing Interface |
| CD-ROM | Compact Disc Read-Only Memory |
| CIMD | Computer Interface to Message Distribution |
| CP | Content Provider |
| CSC | Common Short Code |
| DBMS | Database Management System |
| DRAM | Dynamic Random Access Memory |
| E-Mail | Electronic Mail |
| EMI | External Machine Interface |
| EPROM | Erasable Programmable Read-Only Memory |
| GIS | Geographic Information System |
| GPS | Global Positioning System |
| GW | Gateway |
| HTTP | HyperText Transfer Protocol |
| IM | Instant Messaging |
| IMS | IP Multimedia Subsystem |
| IP | Internet Protocol |
| IQ | Incoming Queue |
| IR | Infrared |
| IVR | Interactive Voice Response |
| LBS | Location-Based Service |
| MAP | Mobile Advertising Platform |
| MEMS | Microelectromechanical Systems |
| MICV | Messaging Inter-Carrier Vendor |
| MMS | Multimedia Message Service |
| MO | Mobile Originated |
| MS | Mobile Subscriber |
| MT | Mobile Terminated |
| NFC | Near Field Communication |
| ODBMS | Object Database Management System |
| OQ | Outgoing Queue |
| P2P | Peer-to-Peer |
| PC | Personal Computer |
| PCMCIA | Personal Computer Memory Card International Association |
| PROM | Programmable Read-Only Memory |
| RAM | Random Access Memory |
| RDBMS | Relational Database Management System |
| RF | Radio Frequency |
| SC | Short Code |
| SIP | Session Initiation Protocol |
| SMPP | Short Message Peer-to-Peer |
| SMS | Short Message Service |
| SP | Service Provider |
| SS7 | Signaling System Seven |
| 3P | Third Party |
| TCP | Transmission Control Protocol |
| TN | Telephone Number |
| UCP | Universal Computer Protocol |
| URL | Uniform Resource Locator |
| WAP | Wireless Application Protocol |
| WC | Wireless Carrier |
| WD | Wireless Device |
| WF | Workflow |
| WS | Web Server |
| WWW | World-Wide Web |
| XML | Extensible Markup Language |

What is claimed is:

1. A method for selecting an advertisement for inclusion within a piece of content, the piece of content to be delivered to a wireless device of a Mobile Subscriber (MS), the method comprising:
(a) receiving the piece of content at a gateway;
(b) evaluating a plurality of predefined campaigns to select a target campaign, the evaluating considering one or more campaign parameters including campaign weight;
(c) selecting an advertisement associated with the target campaign yielding a target advertisement;
(d) including aspects of the target advertisement in the piece of content;
(e) adjusting one or more campaign parameters of the target campaign including campaign weight; and
(f) updating one or more repositories with aspects of the results of steps (b) through (e).

2. The method of claim 1, wherein the piece of content is an Application-to-Peer (A2P) Mobile Terminated (MT) message.

3. The method of claim 2, wherein the A2P MT message is a Short Message Service message.

4. The method of claim 2, wherein the A2P MT message is a Multimedia Message Service message.

5. The method of claim 1, further comprising:
evaluating step (b) further considering aspects of the body of the piece of content.

6. The method of claim 1, further comprising:
evaluating step (b) further considering information provided by the MS during a registration process.

7. The method of claim 6, wherein the registration process captures one or more of (a) identifying information, (b) preference information, (c) demographic information, and (d) billing information.

8. The method of claim 6, wherein the registration process generates a MS profile.

9. The method of claim 6, wherein the registration process is web-based.

10. The method of claim 6, wherein the registration process includes a billing component.

11. The method of claim 6, wherein the registration process generates one or more confirmation messages.

12. The method of claim 11, wherein the one or more confirmation messages are (a) a Short Message Service message or (a) a Multimedia Message Service message.
